(19) United States
(12) Patent Application Publication
(10) Pub. No.: US 2008/0072429 A1
(43) Pub. Date: Mar. 27, 2008

(54) Rotary electric shaver

(75) Inventor: Hiromi Uchiyama, Matsumoto (JP)

Correspondence Address: QUINN EMANUEL;KODA & ANDROLIA, 865 S. FIGUEROA STREET, 10TH FLOOR, LOS ANGELES, CA, 90017, US

(73) Assignee: Izumi Products Company

(21) Appl. No.: 11/893,735

(22) Filed: Aug. 17, 2007

(30) Foreign Application Priority Data
Sep. 22, 2006 (JP) 2006-258071

(51) Int. Cl. B26B 19/14

(52) U.S. Cl. 30/43.6; 30/43.4

(57) ABSTRACT

A rotary electric shaver including a shaver main body, an outer cutter frame attached to the shaver main body and provided with a plurality of circular outer cutter attachment holes, outer cutters formed on the shaving surfaces with hair introduction openings and provided in the outer cutter frame so as to be displaceable inside the outer cutter attachment holes, and inner cutters rotationally driven so as to slide against the outer cutter surfaces formed on the inner surfaces of the shaving surfaces of the outer cutters for cutting hair; wherein an outer cutter mounting hole, formed as a single opening with at least two of the outer cutter attachment holes connected, is provided in the outer cutter frame, and the outer cutters are provided in the outer cutter frame so as to be displaceable inside the outer cutter mounting hole.

### BACKGROUND OF THE INVENTION

1. Field of the Invention

The present invention relates to a rotary electric shaver and more particularly to the outer cutter frame of a rotary electric shaver in which the outer cutters are mounted and further to the manner of providing outer cutters in the outer cutter frame of a rotary electric shaver.

2. Description of the Related Art

Rotary electric shavers include two or three outer cutters mounted in the outer cutter frame. FIG. 17 shows a conventional rotary electric shaver that has three outer cutters mounted in the outer cutter frame. In this rotary electric shaver, the outer cutter frame 12 is detachably mounted to the head part of the shaver main body 5, and three outer cutters 10 are mounted in the outer cutter frame 12. The outer cutter frame 12 is provided with three outer cutter attachment holes 111 for mounting the outer cutters 10 therein, and the outer cutters 10 are provided so that they are displaceable in the mounting holes (see, for instance, Japanese Patent Application Laid-Open (Kokai) 2001-755).

In conventional rotary electric shavers, typically there are two types of methods for mounting the outer cutters in the outer cutter frame. In one type, the outer cutters are secured at positions protruding from the outer surface of the outer cutter frame (from the outer surface of the outer cutter frame that is the surface facing the skin). In another type, the outer cutters are provided so as to be displaceable relative to the outer cutter frame; and in such a displaceable outer cutter configuration, in some shavers, the outer cutters are displaceable while being kept protruding above the outer surface of the outer cutter frame; and in some other shavers, the outer cutters are made displaceable so that the shaving surfaces of the outer cutters sink (or depressed) lower than the outer surface of the outer cutter frame. In the shavers in which the shaving surfaces sink (or depressed) lower than the outer cutter frame, the outer cutters are prevented from striking the skin with a force greater than necessary by such a configuration that the outer cutters sink (or depressed) lower than the outer cutter frame and the skin is thereby supported by the circumferential edges of the outer cutter attachment holes.

FIGS. 18(a) through 18(c) show the relationship between the surface of the skin being shaved and the outer cutters 10 in a conventional rotary electric shaver in which the shaving surfaces 10a of the outer cutters 10 can sink in (or can be lowered) than the outer surface 12b of an outer cutter frame 12 when shaving is performed with a plurality of outer cutters 10 striking the surface of the skin being shaved. In this shaver, the outer cutters 10 mounted in the outer cutter frame 12 are variously displaceable, during the shaving, by the force that the outer cutters 10 are pressed against the skin.

FIG. 18(a) shows a situation that shaving is performed with a plurality of outer cutters 10 being pressed against, for example, a convex area of the face such as the chin and that the outer cutters 10 are pressed so that the shaving surfaces 10a comes to about the same height as that of the outer surface 12b of the outer cutter frame 12. In this case, the outer cutters 10 are displaced, following the surface of the skin being shaved, so that the smooth curvature of the surface of the skin being shaved, which is in a convex shape, remains unchanged.

However, when, from the condition shown in FIG. 18(a), the pressing force against the skin is made stronger, and the outer cutters 10 are, as shown in FIG. 18(b), displaced (or sink) so that the shaving surfaces 10a of the outer cutters 10 reach positions lower than the outer surface 12b of the outer cutter frame 12, then the skin in the vicinity of the rib 12a is supported by the rib 12a, which is located between the outer cutters 10, and will cease sinking down. As a result, in the vicinity of the rib 12a, the outer cutters 10 cease following the skin, and a smooth shaving is no longer performable.

When the pressing force is made even stronger in the interest of a close shave, and the outer cutters 10 are displaced, as shown in FIG. 18(c), so that the entire shaving surfaces 10a of the outer cutters 10 reach positions below the outer surface 12b of the outer cutter frame 12, then the ability of the outer cutters 10 to follow the skin being shaved near the rib 12a declines further.

In conventional rotary electric shavers, the portion of the rib 12a which is between adjacent outer cutters is a portion that does not function as a shaving surface. Accordingly, when shaving is performed and the shaver is moved, the portion between the outer cutters 10 becomes a portion where the shaving is not performed.

### BRIEF SUMMARY OF THE INVENTION

Accordingly, the object of the present invention is to provide a rotary electric shaver that includes a plurality of displaceable outer cutters in an outer cutter frame and more particularly to provide a rotary electric shaver in which the ability of the outer cutter shaving surfaces to follow the surface of the skin being shaved is enhanced, thus providing an improved feeling of shaving, preventing shaving misses from occurring, and making assured shaves possible.

The above object is accomplished by a unique structure of the present invention for a rotary electric shaver that includes a shaver main body, an outer cutter frame which is attached to one end of the shaver main body and provided with a plurality of circular outer cutter attachment holes, outer cutters which are formed on the shaving surfaces thereof with hair introduction openings and provided in the outer cutter frame so as to be displaceable inside the outer cutter attachment holes, and inner cutters which are for cutting hair introduced through the hair introduction openings and linked to and rotationally driven by a drive mechanism provided in the shaver main body so as to slide against outer cutter surfaces formed on inner surfaces of the shaving surfaces of the outer cutters; and in this structure, the outer cutter frame is provided with an outer cutter mounting hole which is in such a form that (at least two of) the outer cutter attachment holes are connected together, and the outer cutters are provided in the outer cutter frame so as to be displaceable inside this outer cutter mounting hole.

In this structure, by outer cutter attachment hole is meant a hole formed as a single independent hole provided in the outer cutter frame for mounting therein an outer cutter; and in the present invention, a plurality of the outer cutter attachment holes each formed as a single hole are connected to form a single outer cutter mounting hole (connected opening). When designing the outer cutter mounting hole, the outer cutters are first suitably provided, and outer cutter attachment holes seen in conventional ones are presumed to be at the positions where those outer cutters are provided, and then the outer cutter attachment holes are connected to form a single outer cutter mounting hole. The outer cutters are provided at the positions of the outer cutter attachment holes which are assumed when designing the outer cutter mounting hole.

In the above-described structure, the outer cutters are provided so that their shaving surfaces can sink in (or depressed) to positions lower than the outer surface of the outer cutter frame (or the outer cutters can sink so that their shaving surfaces are positioned lower than the outer surface of the outer cutter frame). Therefore, even when the outer cutters are pressed against the surface of the skin being shaved with greater than prescribed pressure, the followability of the outer cutters to the contour of, for instance, the face is enhanced so that the shaving surfaces of the plurality of outer cutters conform to the skin surface, the shaving efficiency is enhanced, and burning sensations are suppressed.

Furthermore, each of the outer cutters comprises a first outer cutter element, in which a circular ring-shaped blade formation area is formed, and a second outer cutter element, which is installed inside the first outer cutter element; and this second outer cutter element is provided so as to be displaceable relative to the first outer cutter element. In the following description, by “displaceable” is meant that a component part including the second outer cutter element is able to make an up and down (axial) movement or a tilting movement or both of those types of movements, with respect to another component part including the first outer cutter element.

Because the second outer cutter element is displaceable relative to the first outer cutter element, each of the outer cutters mounted in the outer cutter mounting hole can adapt to and follow the irregularities in the surface of the skin being shaved, thus making assured shavings possible.

In addition, the second outer cutter element is urged, relative to the first outer cutter element, so that the shaving surface thereof protrudes to the outside. Accordingly, it is easier, during shaving, for the shaving surface to follow the concavities or the like in the surface of the skin being shaved. Depending on the pressing force the outer cutters are pressed against the surface of the skin being shaved, it is possible to shave with the shaving surfaces of the outer cutters adaptively contacting the surface of the skin being shaved.

Furthermore, since the first outer cutter element is provided in the outer cutter frame via shafts so as to be displaceable relative to the outer cutter frame, the first outer cutter element can easily tilt about the fulcrum of the shaft during the shaving. Compared to a structure in which the outer cutter is provided in the outer cutter frame so that it is merely capable of moving up and down and tilting, the amount by which the first outer cutter element and the second outer cutter element supported by the first outer cutter element tilt can be made larger, so that followability of the outer cutters with respect to the skin being shaved is enhanced greatly.

Also, in the present invention, the slit-shaped hair introduction openings are formed in the second outer cutter element so that the end portions thereof opened at the outer circumferential side surface of the shaving surface. Accordingly, even long hair is introduced through the hair introduction openings into the outer cutters, and shaving is performed assuredly.

In addition, a shield or shields are provided in a displaceable manner in the outer cutter frame, so that the shield or shields shield(s) the outer cutter mounting hole except the areas occupied by the outer cutters or outer cutter attachment holes. In this structure, it is possible that shaving be performed without the displacement movements of the outer cutters mounted in the outer cutter frame being interfered with and that the shaving be performed without the hair debris escaping out of the shaver head to the outside.

Furthermore, with a structure that the shield or shields are provided so as to be connected to the first outer cutter element, the shield or shields can move to follow the movement of the first outer cutter element, so that the effect of preventing hair debris from escaping to the outside is realized without impairing the shaving action by the outer cutters. The description that the shield or shields are connected to the first outer cutter element is meant to include both cases that the shield or shields are formed integrally with the outer cutters and cases that the shield or shields are formed of a separate material from the outer cutters, such as a resin, for example, and then attached integrally to the outer cutters.

As seen from the above, in the rotary electric shaver according to the present invention, the outer cutters are provided in an outer cutter mounting hole which is comprised of outer cutter attachment holes connected together and formed as a single hole or opening, and there are no ribs between adjacent outer cutters. As a consequence, the surface of the skin being shaved is not deformed by such ribs, and the shaving surfaces of adjacent outer cutters simultaneously follow the surface of the skin being shaved; accordingly, efficient shaving is performed.

In addition, at the portion between adjacent outer cutters, the surface of the skin being shaved is supported by the shaving surfaces of the adjacent outer cutters together, and such an action that the surface of the skin being shaved is supported by one outer cutter for another outer cutter is made, which is similar to the action of the skin being shaved which is supported by the circumferential edges of conventional outer cutter attachment holes. As a result, the skin is prevented from encroaching into the hair introduction openings of the outer cutters, and burning sensations is prevented. The action to support the surface of the skin being shaved by adjacent outer cutters together can be further enhanced by a design that the outer cutters are provided closer together; and with such a structure, the surface of the skin being shaved can be supported more definitely; and, by providing the outer cutters further closer together, shaving misses can be further efficiently prevented.

### BRIEF DESCRIPTION OF THE SEVERAL VIEWS OF THE DRAWINGS

FIG. 1 is a front view of the rotary electric shaver according to one embodiment of the present invention;

FIG. 2 is a top view thereof, showing the outer cutters and outer cutter frame;

FIG. 3 is an enlarged cross-sectional view taken along the lines 3-3 in FIG. 2, showing the structure of one of the outer cutters and an inner cutter corresponding thereto;

FIG. 4 illustrates a configuration of the hair introduction openings formed in the outer cutters;

FIGS. 5(a) and 5(b) are explanatory diagrams showing examples of arrangement of outer cutters and shield(s) in an outer cutter frame;

FIGS. 6(a) and 6(b) are explanatory diagrams showing examples of arrangement of outer cutters;

FIGS. 7(a) and 7(b) are explanatory diagrams showing examples of arrangement of outer cutters and shields in an outer cutter frame, wherein the shields are connected to the outer cutters;

FIGS. 8(a) and 8(b) are explanatory diagrams showing further examples of arrangement of outer cutters and shields in an outer cutter frame, wherein the shields are connected to the outer cutters;

FIGS. 9(a) and 9(b) are explanatory diagrams showing still further examples of arrangement of outer cutters and shields in an outer cutter frame, wherein the shields are connected to the outer cutters;

FIGS. 10(a) and 10(b) are explanatory diagrams showing examples of arrangement in which three outer cutters are mounted in an outer cutter frame, FIG. 10(c) showing in cross-section the detail of the guide pin, the shield, and the outer cutter frame;

FIGS. 11(a) and 11(b) are explanatory diagrams showing examples of arrangement in which three outer cutters are mounted in an outer cutter frame;

FIGS. 12(a) and 12(b) are explanatory diagrams showing further examples of arrangement in which three outer cutters are mounted in an outer cutter frame;

FIG. 13 is an explanatory diagram showing an example of arrangement in which four outer cutters are mounted in an outer cutter frame;

FIGS. 14(a) and 14(b) are explanatory diagrams showing areas shaving is performed with a shaver in which two outer cutters are provided in an outer cutter frame;

FIGS. 15(a) and 15(b) are explanatory diagrams showing the relationship between the outer cutters and the surface of the skin being shaved during shaving;

FIGS. 16(a) and 16(b) are explanatory diagrams showing how the first and second outer cutter elements of one of the outer cutters follow the surface of the skin being shaved;

FIG. 17 shows a conventional rotary electric shaver; and

FIGS. 18(a) through 18(c) are explanatory diagrams showing the actions of the outer cutters in a conventional rotary electric shaver.

### BRIEF DESCRIPTION OF THE SEVERAL VIEWS OF THE DRAWINGS

Preferred embodiments of the present invention will now be described in detail below with reference to the accompanying drawings.

Electric Shaver with Two Outer Cutters

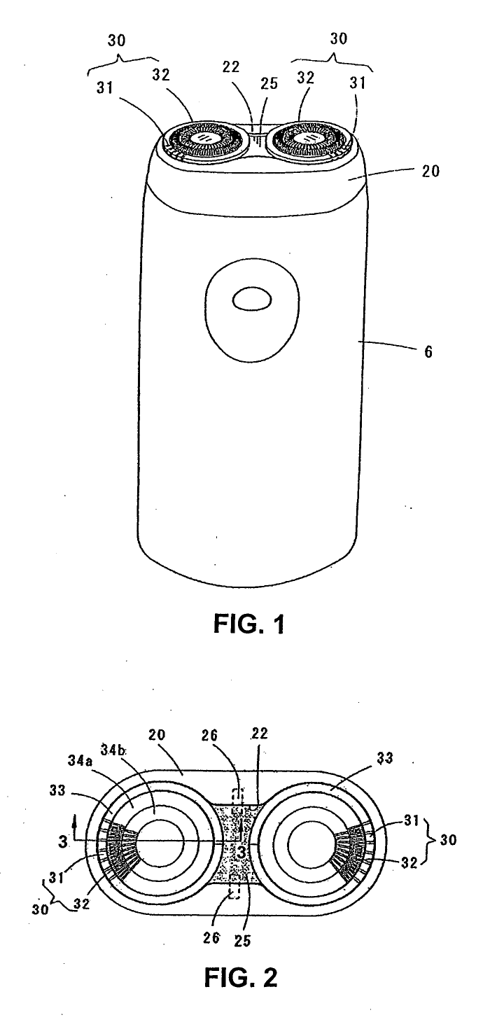

FIG. 1 shows a rotary electric shaver in one embodiment of the rotary electric shaver according to the present invention, and in this shaver, two outer cutters 30 are provided in an outer cutter frame 20.

The outer cutter frame 20 is detachably attached to one end (upper part) of the shaver main body 6 of the electric shaver, and the outer cutters 30 are mounted in the outer cutter frame 20 so as to be displaceable.

In a conventional rotary electric shaver that has two outer cutters, two outer cutter attachment holes are formed in the outer cutter frame so as to be in a round shape respectively and to match the positions where the outer cutters are provided. In the shaver of the shown embodiment of the present invention, however, by way of contrast, two outer cutters 30 are mounted in a single outer cutter mounting hole 22 which is formed by connecting two outer cutter attachment holes together (or is formed continuously by two outer cutter attachment holes).

FIG. 2 shows the outer cutters 30 mounted in the outer cutter frame 20 and seen from the above. The outer cutter frame 20 is in a substantially flat oval shape, the outer cutter mounting hole 22 is formed as one continuous hole in such a manner that two outer cutter attachment holes are connected or formed continuously so that the area in between is formed slightly narrowed inwardly.

The outer cutters 30 are provided so as to be positioned in the circular portions at two ends of the outer cutter mounting hole 22. The outer circumferential side surfaces of the outer cutters 30 are slidable against the inner circumferential side surface of the outer cutter mounting hole 22, and the outer cutters 30 are freely displaceable with respect to the outer cutter frame 20. The outer cutters 30 are tiltable in any direction due to the leeway between the outer cutters and (the inner circumferential side surface of) the outer cutter mounting hole 22.

The configuration of the outer cutters 30 mounted in the outer cutter frame 20 is preferably selected. For example, the entire surface of the shaving surface of the outer cutter can be blade formation area, a circular ring-shaped blade formation area can be formed in the shaving surface, the hair introduction openings provided in the blade formation area can be slits, circular holes, or polygonal holes. Each of the outer cutters 30 in the shown embodiment is comprised of a first outer cutter elements 31, which is in a ring shape and has circular ring-shaped shaving surfaces 33, and a second outer cutter element 32, which is provided in the inside areas surrounded by the first outer cutter element 31. Slit-shaped hair introduction openings are formed in the shaving surface 33 of the first outer cutter elements 31; and two shaving surfaces 34a and 34b are provided concentrically in the second outer cutter elements 32, and in the respectively shaving surfaces 34a and 34b, slit-shaped hair introduction openings are formed.

A shield 25 is provided between the two outer cutters 30 which are installed in the outer cutter mounting hole 22. The shield 25 is for shielding the open area which is between the two outer cutters 30. The shield 25 is provided, so as to be displaceable, in the outer cutter frame 20 with the outer surface thereof sliding against the outer circumferential side surfaces of the outer cutters 30 and against the inner circumferential side surface of the outer cutter mounting hole 22. There are several ways to provide the shield 25 displaceable. In one structure, two guide pins 26 are, as seen from FIG. 2, provided so as to extended toward the shield 25 from the inner side surface of the outer cutter mounting hole 22, and these guide pins 26 are engaged in guide channels formed in the side surfaces of the shield 25. Urging means such as springs or the like can be provided in the guide pins 26 so that the shield 25 always return to the raised or upper position. It is preferable that, when the shield 25 be at the raised (upper) position, the upper surface of the shield 25 be positioned lower than the shaving surfaces of the outer cutters 30.

Outer Cutter and Inner Cutter Configurations

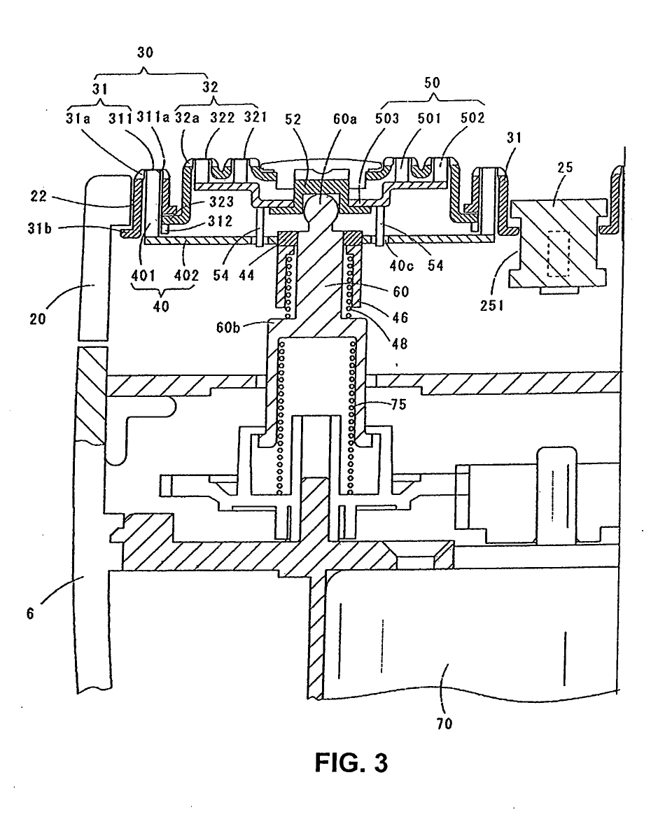

FIG. 3 shows the structure of one of the outer cutters 30 and an inner cutter therefor and the structure of a drive mechanism for rotationally driving the inner cutters.

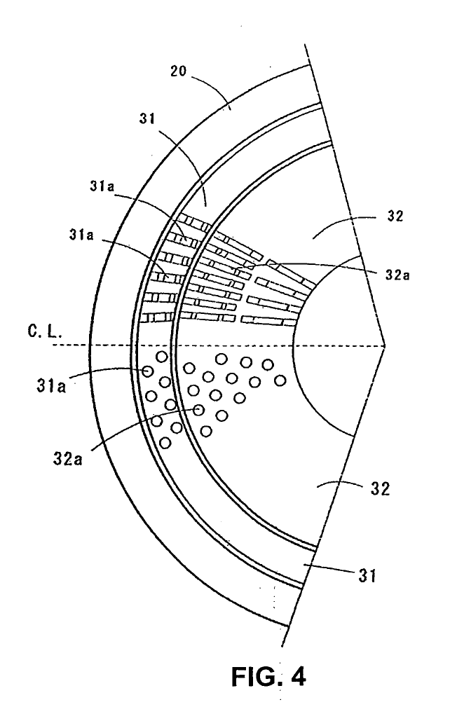

The first (or outside) outer cutter element 31 of the outer cutter 30 has a circular ring-shaped shaving surface 311 that has therein slit-shaped hair introduction openings 31a (see also FIG. 4). The hair introduction openings 31a are provided so as to cut across the shaving surfaces 311 and are open at the upper side surfaces of the first outer cutter element 31.

The first outer cutter element 31 is mounted so that the outer circumferential side surface thereof is slidable against the outer cutter mounting hole 22 formed in the outer cutter frame 20, and a flange 31b provided in the lower edge of the outer circumferential surface of the first outer cutter element 31 engage the outer cutter frame 20. The first outer cutter element 31 is thus prevented from being detached upwardly from the outer cutter frame 20.

Inside the first outer cutter element 31 is provided a first (or outside) inner cutter 40 that is comprised of a plurality of blade elements 401, which slide against outer cutter surface 311a formed in the inner surface of the shaving surface 311, and support plates 402, which have thereon the blade elements 401.

In the second (or inside) outer cutter element 32 of the outer cutter 30, two circular ring-shaped shaving surfaces 321 and 322 are formed concentrically; and in those shaving surfaces 321 and 322, respectively, are formed slit-shaped hair introduction openings 32a (see FIG. 4). The hair introduction openings 32a have end portions that open, at least, at the outer circumferential side surface of the shaving surface 322 on the outer circumferential side.

Outer circumferential convexity 323 is formed on the outer side surface of the second outer cutter element 32, so that the convexity 323 engages guide slit 312 extending in the up and down (or axial) direction in the inner side surface of the first outer cutter element 31. The guide slit 312 of the first (or outside) outer cutter element 31 and the convexity 323 of the second (or inside) outer cutter element 32 can be respectively made in a plurality of numbers (for instance, four slits and four convexities), so that they are provided at a plurality of, for instance four, locations positioned equally spaced in the circumferential direction. Thus, the second outer cutter element 32 tiltable in any direction relative to the first outer cutter element 31 but is prevented from turning.

In the second outer cutter element 32 is provided a second (or inside) inner cutter 50 that is comprised of a plurality of blade elements 501 and 502, which slide against the outer cutter surfaces formed in the inner surfaces of the shaving surfaces 321 and 322, and blade supports 503, which have thereon the blade elements 501 and 502.

In the center portion of the second (or inside) inner cutter 50, an engagement member 52 is secured. This engagement member 52 of the inner cutter 50 engages, detachably, an engagement piece 60a formed at the tip end of a drive shaft 60 that is rotationally driven by a drive motor 70 housed inside the shaver main body 6. The engagement member 52, when engaged with the engagement piece 60a, is able to tilt in any direction and is formed in such a shape that the rotational driving force of the drive shaft 60 is transmitted to the second inner cutters 50.

The support plates 402 of the first (or outside) inner cutter 40 are positioned below the blade supports 503 of the second (or inside) inner cutters 50. Fastening projections 54 extend from the blade supports 503 of the second inner cutters 50 toward the support plates 402 of the first inner cutter 40. In the support plates 402 of the first inner cutter 40, engagement holes 40c are provided, so that the tip ends of the fastening projections 54 of the second inner cutter 50 advance and engage, so that the first inner cutter 40 and the second inner cutter 50 are positioned concentrically.

The above-descried support plates 402 extend from a guide portion 44 that is at the base portions of the plates 402 and slide against the side circumferential surface of the drive shaft 60 so as to guide the first inner cutter 40 in a concentric manner with the drive shaft 60. From the undersurface of the guide portion 44, a cylindrical body 46 extends concentrically in the axial direction of the drive shaft 60 so that the cylindrical body 46 fits on the drive shaft 60. In the cylindrical body 46, a spring 48 is mounted so that it provides a spring action between the base portion of the cylindrical body 46 and a step 60b formed in the middle portion of the drive shaft 60.

In the rotary electric shaver of this embodiment, the drive shaft 60 is urged by a spring 75 in a direction that the second (or inside) inner cutter 50 protrudes to the outside (upward in FIG. 3) and that the second (or inside) outer cutter element 32 is supported so as to protrude to the outside. FIG. 3 shows a situation that the drive shaft 60 is pushed upward to an upward position (protruded position) by the spring-action urging force of the spring 75, so that the second outer cutter element 32 is in its protruded position.

The protruded position of the second outer cutter elements 32 is restricted by the convexity(s) 323 provided on the outer side surface of the second outer cutter element 32 and in touch with the upper edge(s) of the guide slit(s) 312 and by the flange 31b of the first outer cutter element 31 in touch with the inner circumferential edge of the outer cutter mounting hole 22 provided in the outer cutter frame 20.

The protruded position of the first (or outside) outer cutter element 31 is a position where the shaving surface of the outer cutter element 31 protrudes from the outer surface of the outer cutter frame 20 and the shaving surface of the second outer cutter element 32 protrudes from the shaving surface of the first outer cutter elements 31 with the first and second outer cutter elements 31 and 32 protruding.

The shield 25, as seen from FIG. 2, provided between two outer cutters 30, each being of the above-described structure, are supported by the outer cutter frame 20 in such a manner that it can slide against the outer side surfaces of the first (or outside) outer cutter elements 31. In the side surfaces of the shield 25, as seen from FIG. 3, concavities 251 are formed, so that it is possible for the flanges 31b formed in the lower edges of the outer circumferential side surfaces of the first outer cutter elements 31 to slide thereagainst and move up and down (or in the axial direction thereof).

As seen from the above, the first outer cutter elements 31 and the second outer cutter elements 32 are provided so as to be displaceable relative to the outer cutter frame 20, that is, in a so-called floating condition, and shaving is performed in this condition.

FIG. 4 shows the locations of the hair introduction openings 31a and 32a in the shaving surface of the first and second outer cutter elements 31 and 32.

In the shown embodiment, slit-shaped hair introduction openings 31a are formed in the first (or outside) outer cutter element 31 so that the end portions of the hair introduction openings 31a open at the upper outer circumferential side surface of the first outer cutter element 31. Accordingly, hair can be definitely introduced from the outer circumferential sides of each of the outer cutters, which are the hair introduction sides in the first outer cutter elements 31, and shaved.

In the second outer cutter element 32, of the shaving surfaces formed in a circular ring-shape, the shaving surface on the outer circumferential side is provided with the hair introduction openings 32a that open at the outer circumferential side surface and are in a slit-shape, so that hair enters from the outer circumferential side surface of the second outer cutter element 32 into the hair introduction openings 32a. As a consequence, even long hair can be assuredly introduced into the hair introduction openings 31a and 32a and shaved.

FIG. 4 shows, in the lower half below the centerline C.L., an example of circular hair introduction openings 31a and 32a formed in the first and second outer cutter elements 31 and 32. In other words, the hair introduction openings provided in the first and second outer cutter elements 31 and 32 are not limited to slit shapes, and they can be in a circular or polygonal shape.

Examples of Manner of Installation of Two Outer Cutters

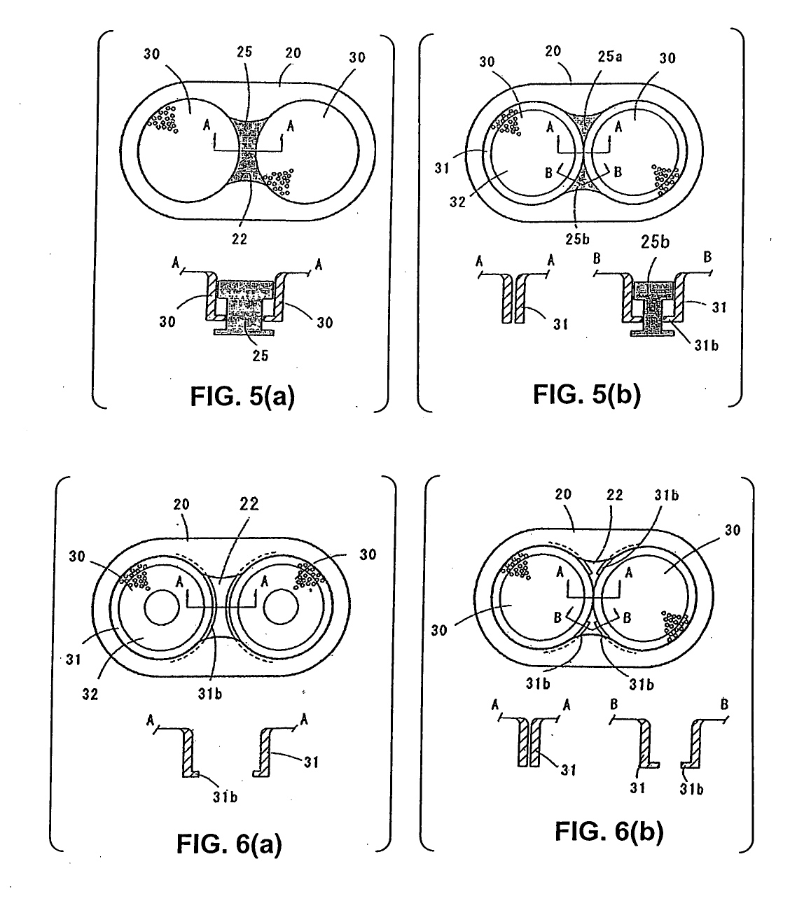

FIGS. 5(a) to 9(b) show the examples of installation of the outer cutters 30 in which two outer cutters 30 are provided in the outer cutter frame 20.

FIGS. 5(a) and 5(b) show the structure with two outer cutters 30 and shield(s) installed in the outer cutter frame 20.

In FIG. 5(a) that includes a top view and a cross-sectional view taken along the lines A-A in the top view, the two outer cutters 30 are provided so that they are or their outer circumferential side surfaces are separated, and one shield 25 is provided between the two outer cutters 30. The outer cutters 30 are respectively provided in the circular hole portions at two ends of the outer cutter mounting hole 22, and the shield 25 is provided in an area facing the two outer cutters 30.

In the shown structure, the shaving surfaces, in their entirety, of the outer cutters 30 are formed as one blade-formation area. The outer cutters 30 are, respectively, comprised of first outer cutter elements 31 and second outer cutter elements 32 disposed inside the first outer cutter elements with the second outer cutter elements 32 being displaceable relative to the first outer cutter elements 31. In the structures below, the blade-formation area formed in the outer cutters 30 and the configuration of the hair introduction openings formed in the outer cutters and the like can be of any suitable and desired configurations.

The above-described outer cutters 30 are provided so that they are displaceable relative to the outer cutter frame 20. The shield 25 is provided also so as to be displaceable relative to the outer cutter frame 20.

In the structure of FIG. 5(b) that includes a top view and cross-sectional views taken along the lines A-A and lines B-B in the top view, the outer cutters 30 are provided in the outer cutter mounting hole 22 so that they are or the outer circumferential side surfaces of the outer cutters 30 are in contact with each other.

In this structure, the outer cutters 30 are provided so as to be displaceable relative to the outer cutter frame 20. Accordingly, in the areas near the positions where the outer circumferential side surfaces of the outer cutters 30 are in contact (on a line joining the centers of the outer cutters 30) with each other, the flanges 31b of the first outer cutter elements 31 are eliminated, and the outer circumferential side surfaces of the first outer cutter elements 31 of the two outer cutters 30 are made so as to slide against each other and to be displaceable. As to the areas sandwiched by the two outer cutters 30, as in the structure of FIG. 5(a), shields 25a and 25b, separate members from the outer cutters 30, are provided. In this structure, there are two shields. The shields 25a and 25b are provided so that their outer side surfaces slide against the outer circumferential side surfaces of the outer cutters 30, and the shields 25a and 25b are provided so that they are displaceable relative to the outer cutter frame 20.

In the above-described structures shown in FIGS. 5(a) and 5(b), the outer cutters 30 and shield 25 or shields 25a and 25b are mounted in the outer cutter frame 20. Thus, in this structure, the outer cutter mounting hole 22 is shielded from the outside, and hair debris accumulating in the shaver head can be prevented from escaping to the outside. In addition, since the shield 25 and shields 25a and 25b are provided so as to be displaceable, they do not interfere the shaving action of the outer cutters 30.

FIGS. 6(a) and 6(b) show the structures in which the outer cutters 30 are provided in the outer cutter mounting hole 22 but not shield(s) is provided. The outer cutters 30 are provided so as to be displaceable relative to the outer cutter frame 20, and the second outer cutter elements 32 of the outer cutters 30 can also be provided so as to be displaceable relative to the first outer cutter elements 31.

In the structure of FIG. 6(a) that includes a top view and a cross-sectional view taken along the lines A-A in the top view, two outer cutters 30 are provided so as to be separated. Because the outer cutter mounting hole 22 is formed as a connected hole, the area between the two outer cutters 30 makes a gap (empty) area. In the area between the outer cutters, as seen from FIG. 6(a), the flanges 31b of the first outer cutter elements 31 of the two outer cutters 30 are visible.

In the structure of FIG. 6(b) that includes a top view and cross-sectional views taken along the lines A-A and lines B-B in the top view, two outer cutters 30 are provided in such proximity as that the outer circumferential side surfaces of the cutters 30 are in contact with each other. As seen from FIG. 6(b), at the point where the outer circumferential side surfaces of the outer cutters 30 make contact, the flanges 31b are eliminated, and the outer circumferential side surfaces of the outer cutters 30 are made to slide against each other such that the outer cutters 30 are displaceable. At places other than where the outer cutters 30 make contact, the flanges 31b are provided on the outer cutters 30. In this structure as well, the portion between the mutually adjacent outer cutters 30 makes a gap (empty) area.

In the above-described structures in which the portion(s) between the mutually adjacent outer cutters 30 is left as a gap(s) or an empty space(s), there is an advantage that the shaver head, including the interior thereof, can easily be cleaned by rinsing with water or the like. This is convenient when rinsing or washing the shaver after one has finished shaving using shaving cream.

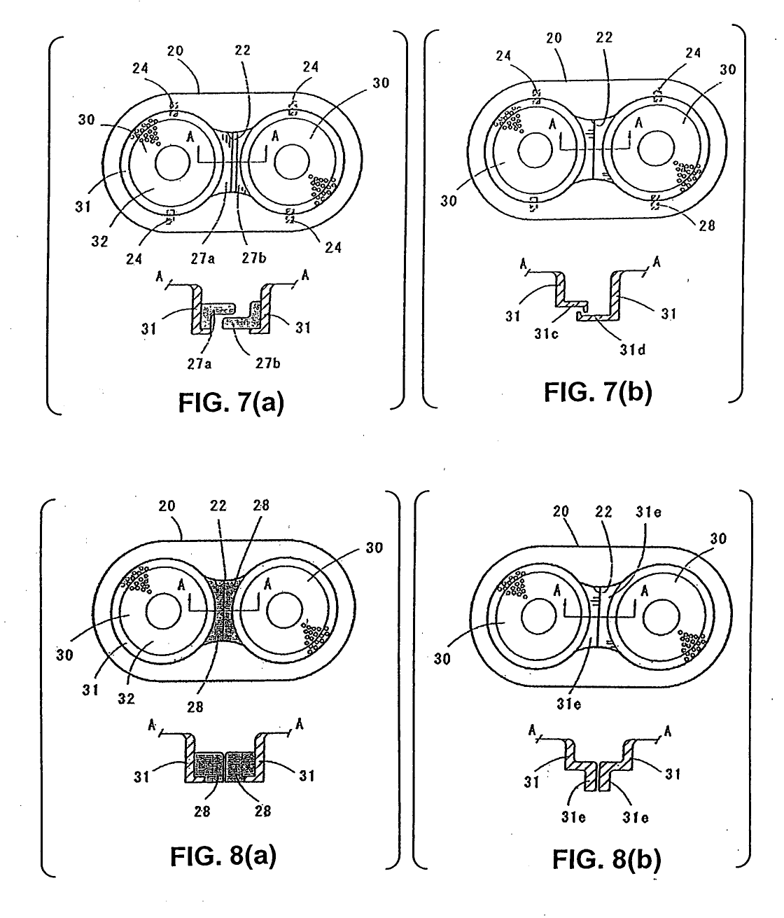

FIGS. 7(a) and 7(b) show the structures in which two shields 25 are provided, and they are connected to the outer cutters 30.

In the structure of FIG. 7(a) that includes a top view and a cross-sectional view taken along the lines A-A in the top view, two outer cutters 30 are provided so as to be separated from each other, and shields 27a and 27b, formed as separate members from the outer cutters 30, are attached to the outer cutters 30, respectively. In this structure, one shield 27a is positioned above the other shield 27b with the end edges of the shields 27a and 27b overlap one on the other. Thus, when the outer cutters 30 having the shields 27a and 27b are set in the outer cutter frame 20, the outer cutter mounting hole 22 is shielded from the outside.

The shields 27a and 27b can be formed of any material. For example, after the outer cutters 30 have been fabricated, the shields 27a and 27b can be configured so as to be attached to the outer cutters 30 by integrally molding a plastic.

In the structure of FIG. 7(b) that includes a top view and cross-sectional views taken along the lines A-A and lines B-B in the top view, shields 31c and 31d are provided integrally with two outer cutters 30. Similar to the structure of FIG. 7(a), one shield 31c is positioned above the other shield 31d, so that the end edges thereof overlap one on the other and the outer cutter mounting hole 22 is shielded by the shields 31c and 31d.

In this structure, because the shields 31c and 31d are respectively integral with the outer cutters 30, it is necessary, during the process of fabricating the outer cutters 30, to build in the shields 31c and 31d.

In the structures that the outer cutters 30 have shields as shown in FIGS. 7(a) and 7(b), the shields are mounted simultaneously when the outer cutters 30 are provided in the outer cutter frame 20.

In the structures of FIGS. 7(a) and 7(b), each of the outer cutters 30 is axially provided in the outer cutter frame 20 by a pair of pivot shafts 24 in their first outer cutter elements 31 so that the outer cutter 30 is tiltable relative to the outer cutter frame 20. The pair of the pivot shafts 24 that axially support each outer cutter 30 via their first outer cutter elements 31 are provided so that the shafts 24 are on an imaginary line which is oriented at right angles to an imaginary line that passes through the center of the corresponding outer cutter 30 and joins the centers of the two outer cutters 30. As a result, the two outer cutters 30 are able to tilt in a direction that they face each other (or tilt inwardly). When the second (or inside) outer cutter elements 32 of the outer cutters 30 are provided, as described earlier, so as to be displaceable and face in any orientation with respect to the first (or outside) outer cutter elements 31, and the first outer cutter elements 31 that have therein the second outer cutter elements 32 are supported in the outer cutter frame 20 by the shafts 24 so as to be tiltable as described above, then in addition to the tilting motion of the first outer cutter elements 31, the second outer cutter elements 32 are displaced in the first outer cutter element 31; and as a result, the outer cutters can follow the surface of the skin being shaved further snugly and smoothly.

FIGS. 8(a) and 8(b) show the structures in which shields are connected to the outer cutters 30, and the outer cutters 30 are provided so as to be displaceable relative to the outer cutter frame 20.

More specifically, in the structure of FIG. 8(a) that includes a top view and a cross-sectional view taken along the lines A-A in the top view, shields 28, which are separate members from the outer cutters 30, are attached to the two outer cutters 30, respectively, so that the side surfaces of the shields 28 are slidable against each other. As a result, the outer cutters 30 are movable and displaceable while the shields 28 are in a sliding condition with each other. The shields 28, made of a plastic or the like, can be formed integrally with the outer cutters 30; and in this structure in which the shields 28 are integral with the outer cutters 30, the shields 28 are installed in the outer cutter frame 20 merely by setting the outer cutters 30 in the outer cutter frame 20. Thus, the assembly operation is simple.

In the structure of FIG. 8(b) that includes a top view and a cross-sectional view taken along the lines A-A in the top view, shields 31e, with the outer side surfaces thereof being slidable against each other, are provided integrally with the outer cutters 30. The shields 31e can thus be provided integrally with the outer cutters 30. In this structure as well, when the outer cutters 30 are displaced, the side surfaces of the shields 31e slide against each other, and shaving can be accomplished without interfering with the displacement of the outer cutters 30. In addition, hair debris can be prevented from escaping to the outside from the shaver head.

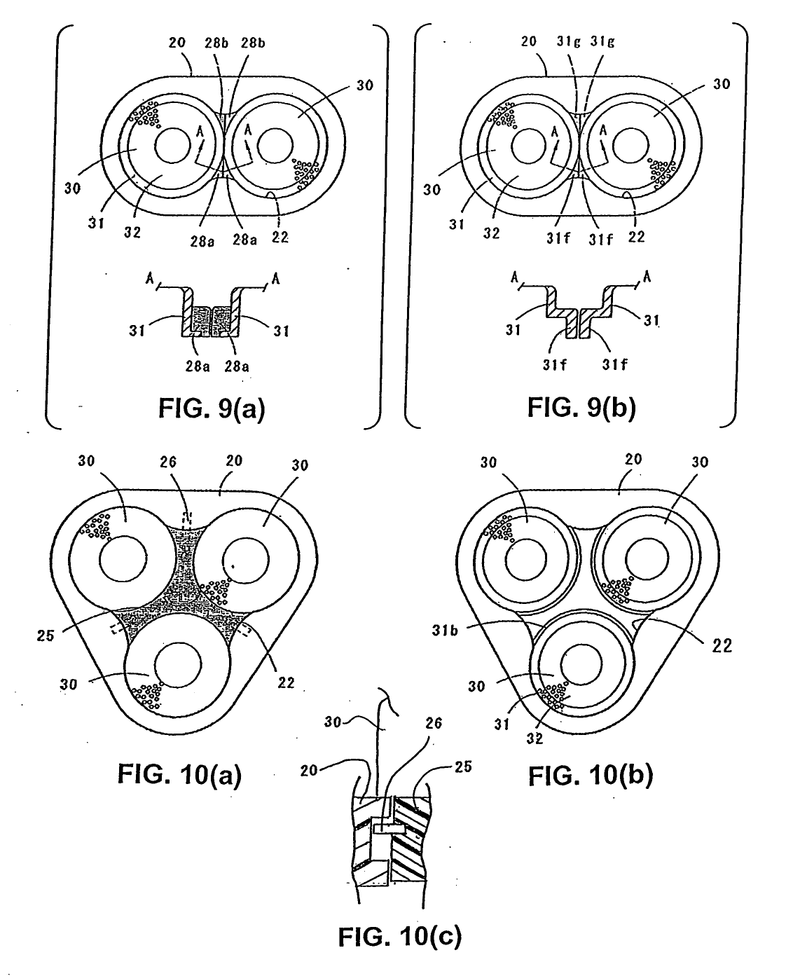

FIGS. 9(a) and 9(b) show the structures in which the outer cutters 30 are provided so that the outer circumferential side surfaces thereof make contact with each other, and shields are connected to the outer cutters 30.

More specifically, in FIG. 9(a) that includes a top view and a cross-sectional view taken along the lines A-A in the top view, shields 28a and 28b are provided as separate members from the outer cutters 30; while in FIG. 9(b) that includes a top view and a cross-sectional view taken along the lines A-A in the top view, shields 31f and 31g are provided integrally with the outer cutters 30. In either case, the shields 28a and 28b and the shields 31f and 31g are positioned on both sides where the outer circumferential side surfaces of the outer cutters 30 slide against each other; and further the outer circumferential side surfaces of the outer cutters 30 slide against each other where the outer cutters 30 make contact, and the end edges of the shields 28a and 28b and of the shields 31f and 31g, respectively, slide against each other.

Electric Shaver Comprising Three or More Outer Cutters

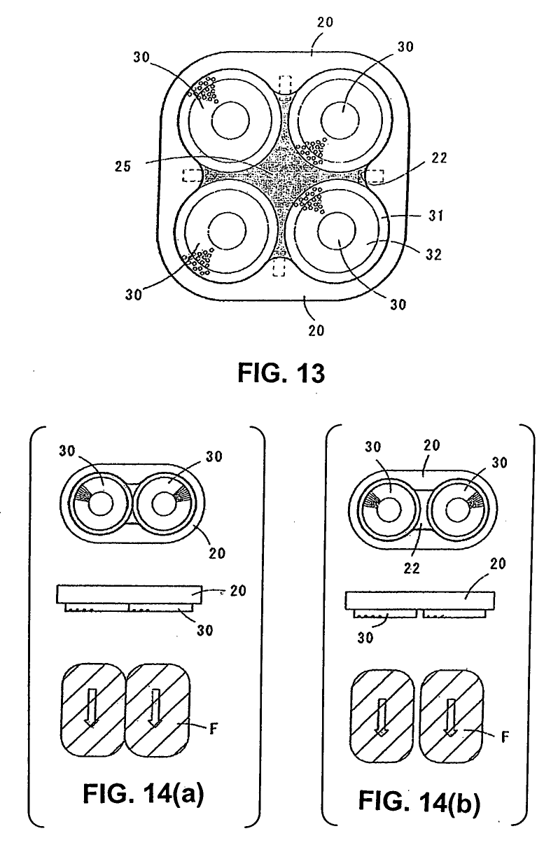

In the embodiments described above, two outer cutters 30 are provided in the outer cutter frame 20; however, the present invention is further applicable to shavers in which three or more outer cutters 30 are provided in outer cutter frames. FIGS. 10(a) to 12(b) show the shavers having three outer cutters 30 in the outer cutter frame 20, and FIG. 13 shows an example in which four outer cutters 30 are installed.

More specifically, in the structures of FIGS. 10(a) and 10(b), the outer circumferential side surfaces of the outer cutters 30 are separated from each other, and three outer cutters 30 are provided so that their centers are positioned at the apexes of an equilateral triangle. In FIG. 10(a), a shield 25 is provided between adjacent outer cutters 30; and in FIG. 10(b), no shield is provided, and the portion between the outer cutters 30 makes a gap (or an empty space). In either structure, the outer cutter mounting hole 22 has circular outer cutter attachment holes provided at the apexes of an equilateral triangle, and the outer cutter mounting hole 22 is formed so that three outer cutter attachment holes are connected (or are formed continuously) to make a single opening and that the outer cutters 30 are installed, respectively, at positions of the outer cutter attachment holes.

In the structure that includes the shield 25 as shown in FIG. 10(a), the shield 25 is installed so as to ascend and descend in the outer cutter frame 20 by guide pins 26 or the like, so that, by way allowing the outer circumferential side surfaces of the outer cutters 30 and the outer side surfaces of the shield 25 to slide against each other, shaving is made possible without any interference by the shield 25.

In the structure of FIG. 10(b), the outer cutters 30 are installed in the outer cutter frame 20 so that they are displaceable. It is thus possible that shaving is performed so that the outer cutters 30 snugly and smoothly follow the contour of the surface of the skin being shaved.

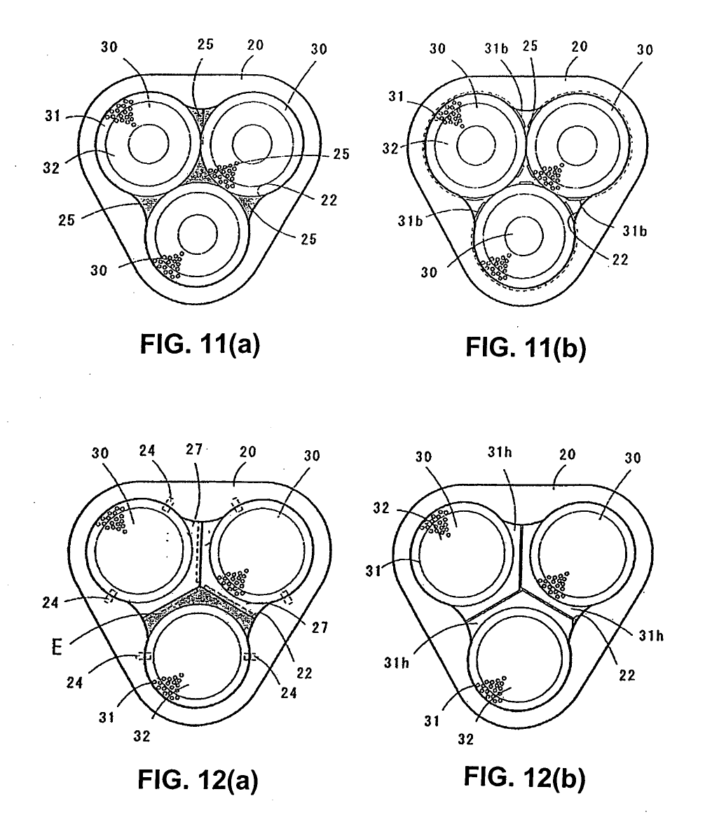

FIGS. 11(a) and 11(b) show the examples in which three outer cutters 30 are provided so that their outer circumferential side surfaces are in contact with each other. The structure of FIG. 11(a) uses a shield 25, and the structure of FIG. 11(b) uses no shield 25. The shield 25 in FIG. 11(a) is comprised of four parts.

When the outer cutters 30 are provided so that the outer circumferential side surfaces thereof contact each other, as in this embodiment, it is possible to provide the outer cutters 30 in a compact arrangement in the outer cutter frame 20. When no shield is provided between the three outer cutters 30 as shown in FIG. 11(b), such an advantage is gained that the operation of cleaning of the interior of the shaver head by water rinsing can be made simple. Furthermore, when no shield is provided as in the structure of FIG. 10(b), and empty spaces are provided between (among) the outer cutters 30, the operation of cleaning of the interior of the shaver head by water rinsing can be made further simple.

In the structures of FIGS. 12(a) and 12(b), shields are provided so that they are connected to the outer cutters 30. In FIG. 12(a), shields 27 formed as separate members from the outer cutters 30 are attached to the outer cutters 30, and the shields 27 are provided in such an arrangement that the end edges of the shields 27 of the adjacent outer cutters 30 are overlapped (see the dashed lines). The area defined by E represents a shield 27 for one outer cutter 30 (only one of three E areas is shown in FIG. 12(a)). The manner of the shields 27 connected to the outer cutters is the same as that of FIG. 7(a).

In each one of the outer cutters 30, the first (or outside) outer cutter element 31 is axially supported in the outer cutter frame 20 by two pivot shafts 24 as shown in FIG. 12(a). More specifically, the pivot shafts 24 for an outer cutter 30 are provided on an imaginary diametrical line that passes through the center of the corresponding outer cutter and is perpendicular to an imaginary line that connects the center of the corresponding outer cutter and a symmetrical center of other two outer cutters. As a result, the respective outer cutters 30 is tiltable toward the symmetrical center of the outer cutter mounting hole 22 in which the other two outer cutters 30 are installed. By installing, in each one of the outer cutters 30, the second (or inside) outer cutter element 32 displaceable relative to the first (or outside) outer cutter element 31, the outer cutters 30 can furthermore snugly and smoothly follow the contour of the surface of the skin being shaved.

In the structure of FIG. 12(b), shields 31h are provided integrally with the outer cutters 30; and in this structure, the shields 31h for adjacent outer cutters 30 are provided so as to be slidable against each other, as shown in FIG. 8(b), and the outer cutters 30 are individually displaceable relative to the outer cutter frame 20.

In the structure of FIG. 12(a), the shields 27 can be provided directly on the outer cutters 30; and in the structure of FIG. 12(b), the shields 31h can be separate members from the outer cutters 30.

FIG. 13 shows an example in which four outer cutters 30 are provided in the outer cutter frame 20.

In this structure as well, the outer cutter mounting hole 22 of the outer cutter frame 20 is formed as a single opening. Four outer cutters 30 are respectively provided at four corners of the outer cutter mounting hole 22; and a shield 25, displaceable relative to the outer cutter frame 20, is provided in the portion between the outer cutters 30 which are adjacent in the planar area of the outer cutter mounting hole 22. Instead of providing the shield 25, the spaces between the adjacent outer cutters 30 can be made empty areas. Because the outer cutter mounting hole 22 is a single opening, it is possible to provide the outer cutters 30 in such a degree of proximity that the outer circumferential side surfaces thereof can contact each other. It is also possible that the outer cutters 30, respectively, are comprised of first outer cutter elements 31 and second outer cutter elements 32 and that the second outer cutter elements 32 are displaceable relative to the first outer cutter elements 31. In the structures of this embodiment as well, shaving can be performed with the shaving surfaces of the outer cutters 30 superficially contacting the surface of the skin being shaved.

Actions of the Rotary Electric Shaver

In the rotary electric shaver according to the present invention, as seen from the embodiments described above, the outer cutter mounting hole 22 provided in the outer cutter frame 20 is formed as a single opening. Accordingly, when the outer cutters 30 are provided in the outer cutter frame 20, the outer cutters 30 can be provided in such a degree of proximity as that the outer circumferential side surfaces thereof are in contact with each other. Thus, the outer cutters 30 can be provided more compactly (or closer to each other) than in a conventional electric shaver, and it becomes possible to reduce shaving misses when shaving is performed.

FIGS. 14(a) and 14(b) show, using an electric shaver that has two outer cutters 30 provided in the outer cutter frame 20, the shaving areas in which the electric shaver is moved to perform shaving.

In the structure of FIG. 14(a), the outer cutters 30 are provided in the outer cutter frame 20 so that their outer circumferential side surfaces are in contact with each other. In this structure, when shaving is performed by way of moving the shaver in a direction (shown by arrows) that is perpendicular to the direction in which the outer cutters 30 are aligned, the two shaving areas F are in contact with each other, and shaving is performed without causing substantially any shaving misses.

In the structure of FIG. 14(b), the outer cutters 30 are slightly separated from each other so that their outer circumferential side surfaces are not in contact with each other. In the rotary electric shaver of the present invention, it is, as described above, possible to provide the outer cutters 30 in closer proximity than in conventional electric shavers; accordingly, it becomes easy to make such provision that the shaving areas F are more proximate, and missed shaving portions are reduced.

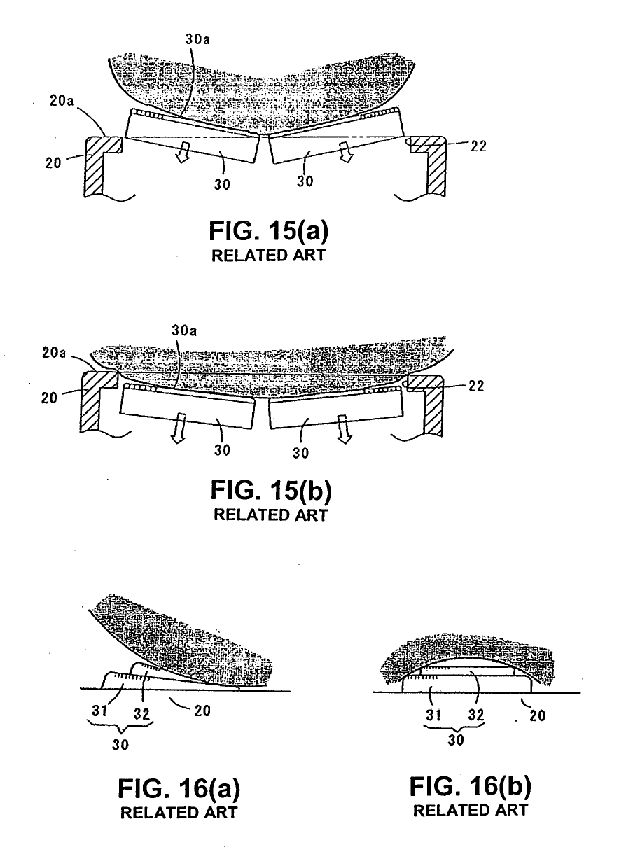

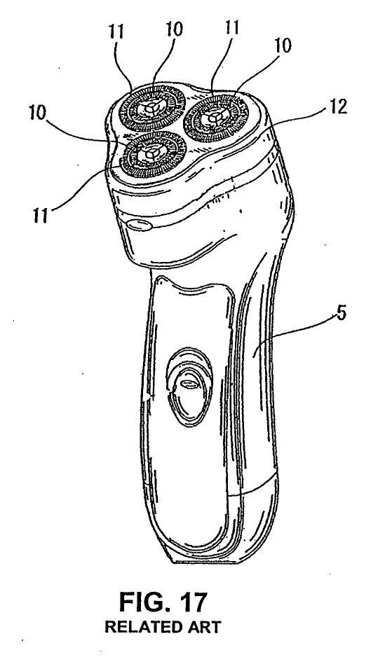

FIGS. 15(a) and 15(b) show the relationship between the outer cutters 30 and the surface of the skin being shaved when shaving is performed by way of pressing the plurality of outer cutters 30 of the rotary electric shaver of the present invention simultaneously against the surface of the skin being shaved. In FIG. 15(a), a convex surface of the skin being shaved is pressed against the outer cutters 30, with the shaving surfaces 30a of the outer cutters 30 positioned upward from the outer surface 20a of the outer cutter frame 20; and in FIG. 15(b), the pressing force in excess of prescribed pressure is applied, and the shaving surfaces 30a of the outer cutters 30 in their entirety are displaced below the outer surface 20a of the outer cutter frame 20.

In the rotary electric shaver according to the present invention, because the ribs formed in conventional rotary electric shavers are not provided, when the outer cutters 30 are pressed against the surface of the skin being shaved, the surface of the skin being shaved is not deformed by the ribs, and the adjacent outer cutters 30 make a good contact with the surface of the skin being shaved while that surface of the skin being shaved is left in a condition that a uniformly smooth shape is maintained. Accordingly, the ability of the outer cutters 30 to follow the surface of the skin being shaved is high, and efficient shaving is made possible.

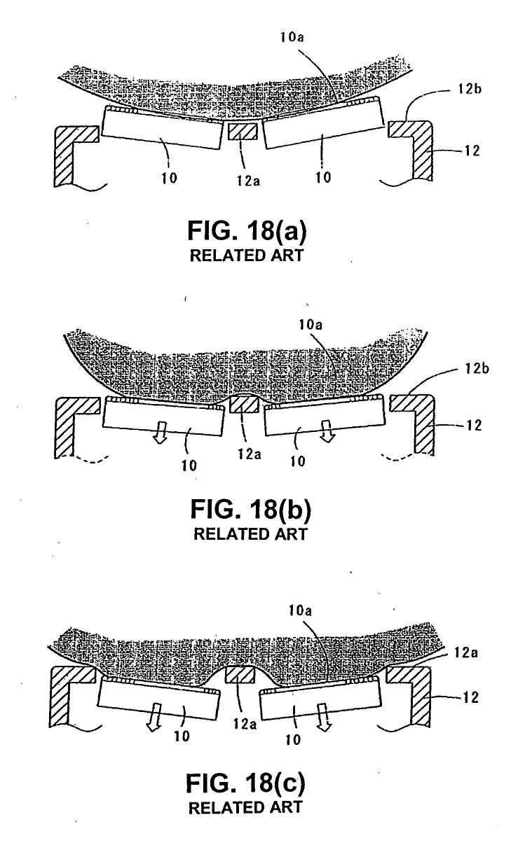

In the present invention, the ability of the outer cutters 30 to follow the surface of the skin being shaved during shaving is unchanged whether in cases where the shaving surfaces 30a of the outer cutters 30 are positioned higher than the outer surface 20a of the outer cutter frame 20 (FIG. 15(a)), in cases where some portion of the shaving surface 30a of the outer cutters 30 is positioned lower than the outer surface 20a of the outer cutter frame 20, or in cases where the entirety of the shaving surfaces 30a of the outer cutters 30 is positioned lower than the outer surface 20a of the outer cutter frame 20 (FIG. 15(b)). This is significantly different from the actions of the conventional shaver between the surface of the skin being shaved and the outer cutters 10 shown in FIGS. 18(a) through 18(c).

In the rotary electric shaver of the present invention, furthermore, the skin being shaved is supported in a smooth curved surface shape by the outer cutters 30; and in addition, in the areas between adjacent outer cutters, the adjacent outer cutters together act to support (lift up) the surface of the skin being shaved so that, for one outer cutter 30, another outer cutter 30 can lift up the surface of the skin being shaved. Therefore, the skin being shaved is prevented from forcibly striking a corner of an outer cutter 30, and the skin is prevented from encroaching into the hair introduction openings of the outer cutters 30. As a consequence, burning sensations during shaving are prevented in the shaver of the present invention.

Furthermore, in the present invention, it is possible to easily provide adjacent outer cutters in close proximity. Accordingly, by providing the outer cutters together in closer proximity, the action of supporting the surface of the skin being shaved by the outer cutters together is strengthened, and deformation of the surface of the skin being shaved is thereby further prevented, so that the followability between the outer cutters and the surface of the skin being shaved and the action to prevent burning sensations can be both enhanced. Also, with the outer cutters provided in close proximity, the benefit of fewer shaving misses is also realized.

Furthermore, in the structure of the present invention, the first (or outside) outer cutter elements 31 and second (or inside) outer cutter elements 32 are provided in the outer cutters 30, and the second outer cutter elements 32 can be made to be displaceable relative to the first outer cutter elements 31 as described in the embodiments. This structure enhances the followability of the outer cutters with the surface of the skin being shaved.

FIGS. 16(a) and 16(b) show the actions of the outer cutters 30 which are provided so that the second outer cutter elements 32 are displaceable in the first outer cutter elements 31, and the second outer cutter elements 32 are urged so that the shaving surfaces of the second outer cutter elements 32 protrude from the shaving surfaces of the first outer cutter elements 31.

FIG. 16(a) shows a situation that an outer cutter 30 is brought into contact with a convex portion of the skin being shaved. In this case, the shaving surfaces of the outer cutter are adjustable to the convex portion of the surface of the skin being shaved since the first outer cutter element 31 and the second outer cutter element 32 are both tilted.

In FIG. 16(b), it is shown that an outer cutter 30 is brought into contact with a concave portion of the skin being shaved. In this case, shaving is performed with the shaving surface of the outer cutter 30 exactingly following the concave portion of the skin being shaved due to the shaving surface of the second outer cutter element 32 protruding more than the shaving surface of the first outer cutter element 31.

As seen from the above, in the rotary electric shaver of the present invention, the ability of the outer cutters 30 to follow the surface of the skin being shaved is enhanced, and the shaving surfaces of the outer cutters 30 superficially contact the surface of the skin being shaved. Accordingly, when the outer cutters are comprised of the first outer cutter elements 31 and second outer cutter elements 32, the skin surface will contact both cutter elements, and efficient shaving is assured.

1. A rotary electric shaver comprising:
a shaver main body,
an outer cutter frame attached to one end of said shaver main body and provided with a plurality of circular outer cutter attachment holes,
outer cutters formed on shaving surfaces thereof with hair introduction openings and provided in said outer cutter frame so as to be displaceable inside said outer cutter attachment holes, and
inner cutters which are for cutting hair introduced through said hair introduction openings and linked to and rotationally driven by a drive mechanism provided in said shaver main body so as to slide against outer cutter surfaces formed on inner surfaces of said shaving surfaces of said outer cutters; wherein
an outer cutter mounting hole, which is in such a form that at least two of said outer cutter attachment holes are connected together, is provided in said outer cutter frame, and
said outer cutters are provided in said outer cutter frame so as to be displaceable inside said outer cutter mounting hole.

2. The rotary electric shaver according claim 1, wherein said outer cutters are provided so that shaving surfaces thereof are displaceable to positions lower than an outer surface of said outer cutter frame.

3. The rotary electric shaver according to claim 1, wherein
each of said outer cutters comprises a first outer cutter element that has a circular ring-shaped blade formation area, and a second outer cutter element which is provided inside said first outer cutter element; and
said second outer cutter element is displaceable relative to said first outer cutter element.

4. The rotary electric shaver according to claim 3, wherein said second outer cutter element is urged so that a shaving surface thereof protrudes outward with respect to said first outer cutter element.

5. The rotary electric shaver according to claim 3, wherein said first outer cutter element is axially supported by said outer cutter frame so as to be displaceable.

6. The rotary electric shaver according to claim 3, wherein slit-shaped hair introduction openings are formed in said second outer cutter element so that end portions thereof are opened at outer circumferential side surface of the shaving surface.

7. The rotary electric shaver according to any one of claims 1 to 6, further comprising at least one shield provided so as to be displaceable in said outer cutter frame, said shield shielding said outer cutter mounting hole except areas occupied by said outer cutter attachment holes.

8. The rotary electric shaver according to claim 7, wherein said shield is provided so as to be connected to said first outer cutter element.
